(19) United States
(12) Patent Application Publication
(10) Pub. No.: US 2002/0154751 A1
(43) Pub. Date: Oct. 24, 2002

(54) Method for managing wireless communication device use including optimizing rate and service plan selection

(76) Inventors: Richard H. Thompson III, Superior, CO (US); Edward Sacharuk, Aurora, CO (US); Michael John Kenyon, Aurora, CO (US); Molly Joy Schoonover, Denver, CO (US); Dhiraj Soni, Denver, CO (US); William Bell, Littleton, CO (US)

Correspondence Address: Kent A. Lembke, Esq., Hogan & Hartson, LLP, Suite 1500, 1200 17th Street, Denver, CO, 80202, US

(21) Appl. No.: 10/007,637

(22) Filed: Oct. 18, 2001

Related U.S. Application Data
(60) Provisional application No. 60/241,461, filed on Oct. 18, 2000.

(51) Int. Cl. H04M 15/00; H04M 7/00

(52) U.S. Cl. 379/114.01; 379/221.02

(57) ABSTRACT

A wireless account management system including an account manager system, customer systems, and carrier systems linked by the Internet. The account manager system includes a management tool adapted with a data loader for receiving billing and usage data from the carrier systems and converting it to a single format for storage in a management database. The data loader allows carrier system data having a similar format but differing data arrangement, carrier system data having different formats, and carrier system data having a format not readily parsed all to be processed and parsed into files having a single format. Plaintext files are parsed by a text parser and carrier-specific files are parsed by modules provided to interpret corresponding carrier's bills. An optimization engine uses usage reports created from call detail records, lists of available service plans, and customer-provided and carrier-specific criteria to create plan recommendations for each wireless device.

### CROSS-REFERENCE TO RELATED APPLICATIONS

This application claims the benefit of U.S. Provisional Application No. 60/241,461, filed Oct. 18, 2000.

### BACKGROUND OF THE INVENTION

1. Field of the Invention

The present invention relates, in general, to telecommunications and wireless communication devices, and, more particularly, to a system and method for managing the use of such devices on a large scale, such as a corporate setting, including selecting rate and/or service plans based on user selectable parameters and previously received and processed wireless invoices and monitoring and controlling use of such devices in planning and ongoing or real time modes.

2. Relevant Background

The use of wireless communication devices, such as digital and cellular telephones, has rapidly expanded worldwide but methods of managing corporate use and costs have not kept pace. Businesses often purchase or lease large numbers of wireless communication devices for use by their employees. A recent study indicated that businesses use 40 percent of the cellular telephones in the United States, which amounts to 30 to 40 million or more cellular telephones. Each of these cellular telephones is provided communication services based on one of many service plans available from one or more service providers or resellers that bill the business according to usage and the rates applicable to the service plan (recently estimated at more than 5000 plans within the United States alone). Clearly, as the number of wireless communication devices used by a business and service plans available increases, the importance and difficulty of efficiently and effectively managing the selection of service providers and service or rate plans increases. Additionally, controlling or at least monitoring employee usage of the wireless communication devices becomes more important for controlling business expenses.

Presently, the average business expense per wireless communication device is $80 per billing period and results in a business receiving up to seven pages of paper each billing period for each device. For example, a smaller business with a fleet of one hundred devices receives up to one hundred separate invoices with employee usage, rate plan information, and total cost information spread over seven hundred pages of paper. Service providers or carriers often make no effort to clarify the information because it is typically in the best interest of the service provider for the customer to retain current service plans. However, carriers change and add to their wireless service plans often to remain competitive, sometimes within a single billing period, and failure to take advantage of new plans and plan changes as they become available (rather than months later) can result in significant missed reductions of communication expenses for businesses. It has been estimated that many users of wireless communication devices are not using the most cost effective plan based on their usage and that switching to a more cost effective plan would result in savings of 30 to 50 percent.

Administrative costs for managing wireless communication device use are also unacceptably high for businesses. Existing management techniques are generally manual and involve one or more employees spending a large amount of time paying the invoices and, only in some cases, evaluating the invoices. Manual evaluation of the invoices is a very time consuming, repetitive task that presents a prohibitive cost with any savings achieved in efficient management and selection being wiped out by the labor costs. Effective evaluation that leads to switching service plans also generally requires intimate understanding of all of the numerous service plans presently available to the business and/or its employees. This is a nearly impossible manual task that results in the business simply making no switch or making switches on a company-wide basis, which results in cost savings for some users but increased costs for others due to differing usage patterns (e.g., different volume, geography, timing of calls, and the like). It is also very difficult for an administrator to identify employee misuse of their wireless device for personal use based on the received invoices. Most businesses have policies intended to limit personal use of wireless devices but have no objective standards for determining excessive use or even for identifying personal use.

Some efforts have been made by wireless carriers to make the analysis of wireless telephone invoices less manual to assist in selecting a service plan. These efforts have not been widely adopted by businesses in part because the analysis is typically performed over a number of months prior to providing a recommendation. This delayed recommendation is often not useful in the new service environment in which carriers change service plans frequently and often, within billing periods. Additionally, the existing computerized analysis methods are typically based simply on usage volumes, e.g., minutes of peak and off-peak usage, by each user and result in a recommendation of a less costly available plan. The result is a flat report that does not facilitate manipulation by administrators or others wanting to investigate gathered user, usage, and plan data. The result is generally based solely on cost with no or few other business goals being accounted for (such as flexibility in time of use or geography or other business needs or parameters) in the analysis.

Additionally, existing analysis systems are generally not readily adapted for changing service plans or for modeling future uses and/or service plans. Further, prior to analyzing the data, the data must be converted into a form expected by the analysis software. This conversion task is complicated by the use of multiple carriers that provide their invoices in various forms, and the task is usually performed by manual data entry or manipulation into an accepted form for further processing.

Hence, there remains a need for an improved method and system for managing wireless communication device use by multiple users of an organization. Preferably, such a method and system would be cost effective and relatively easy to implement within existing business structures, allow analysis parameters to be input and changed by administrators or other users of the method and system, provide accurate real-time recommendations for service plan changes on a user-by-user basis, company-wide basis, and/or geographical region basis, and facilitate monitoring or policing of individual employee usage.

### SUMMARY OF THE INVENTION

The present invention addresses the above discussed and additional problems by providing a wireless account management system including an account manager system, one or more customer systems (i.e., clients), and one or more carrier systems (i.e., wireless service providers) linked by the Internet or other communication network. The account manager system includes a management tool that is adapted with a data loader for receiving billing and usage data from the carrier systems and converting it to a single unified format for storage in a management database. The data loader is an important part of the invention as it allows carrier system data having a similar format but differing data arrangement, carrier system data having very different formats, and carrier system data having a format that is not readily parsed all to be processed and parsed into records or files in a management database having a single, useful format. To this end, the data loader includes an initial converter that separates the incoming files into carrier-specific and parsable files and into plaintext files. The plaintext files are parsed by a text parser module into single-format output files and each of the carrier-specific files is sent to a parser module provided specifically to interpret the corresponding carrier's bills. All of the parsed files are stored for later use in a management database.

According to one important aspect of the invention, the single-format stored data is processed by an optimization engine to generate recommendation reports indicating for each customer device the preferred carrier service plans. The optimization process involves processing all incoming billing information (previously stored in the management database as single-format data) to identify devices included on the bills and for each of the devices determining that device's usage over a set analysis period (one billing period, two billing period, three billing periods, and the like). Significantly, the usage or usage report is built based on call data records (CDRs) for each call rather than just on summary report, which better captures all call data not just billed usage and allows the determination of average call duration and the range of call durations, each of which is useful in obtaining better fits to the available service plans. The usage by employees is also monitored against a preset alarm level or usage level (e.g., expected use is less than a set number of calls and/or set amount of time), which once exceeded results in the system issuing a misuse alert to the customer or flagging the employee's file for inclusion in a recommendation report.

A list is created of each presently available plan and each plan is analyzed first based on the determined usage. The “costed” plans are then pared down by eliminating those that do not meet client-provided parameters (such as a required cost savings prior to being recommended) and then by eliminating plans determined to be not valid based on carrier-specific criteria (such as requirement for a minimum number of devices being serviced under a plan and the like). The remaining plans are ranked by cost and stored in the management database where they are accessible by the customer or from which they are transmitted directly to the customer in recommendation reports.

According to another important aspect of the invention, the account manager system is configured with a data model set that provides a data structure that creates a unique arrangement of the single-format stored data with useful links to the database information. The data models are accessible by users of the system based on their user access levels (e.g., a system or tool administrator may have more detailed access, a noncustomer visitor may only have limited access, and a customer's administrator may have access to company and employee usage, cost, and recommendation data). Significantly, the data models are preferably designed to be active to allow users to drill down or link to related data or records to view all accessible data in a useful, relational fashion. Additionally, based on a user's access level, the user may be able to view and modify data in the management database to affect system operation (such as recommendation reports), to create more customer-specific and useful recommendation reports and in some cases, to facilitate usage modeling and planning.

### BRIEF DESCRIPTION OF THE DRAWINGS

FIG. 1 illustrates a wireless account management system according to the present invention illustrated in a distributed computing environment.

FIGS. 2-6 are exemplary data models illustrating useful relationships for the data in the management database of FIG. 1.

FIG. 7 is a functional block drawing of data flow into, within, and out of the data loader of FIG. 1 illustrating the use of multiple parser modules to parse differing carrier-provided data and differing data formats to produce a consistent formatted output for further processing.

FIG. 8 is a flow chart of one exemplary recommendation or optimization process carried out by the wireless account management system of FIG. 1.

### DETAILED DESCRIPTION OF THE PREFERRED EMBODIMENTS

The present invention provides a wireless account management system and associated method that enhances a business or entity's ability to effectively monitor communication device (e.g., wireless or traditional telephone) usage and to control costs by facilitating informed service or rate plan selection. In general, the system of the present invention processes the large volumes of invoices or bills received in paper or digital form from carriers providing service for a customer of the system. The processed information is uniquely arranged within a data structure that can then be accessed by different users (e.g., customer administrators, customer employees, site or system visitors, account manager tool administrators, and others) of the system to view (such as on a Web page) particular data models. Access to information and which data model is available is typically set by user access level or user clearance. Each user preferably can drill down in accessible data models to collect or mine information relative to their needs rather than relying on a flat report of recommendations.

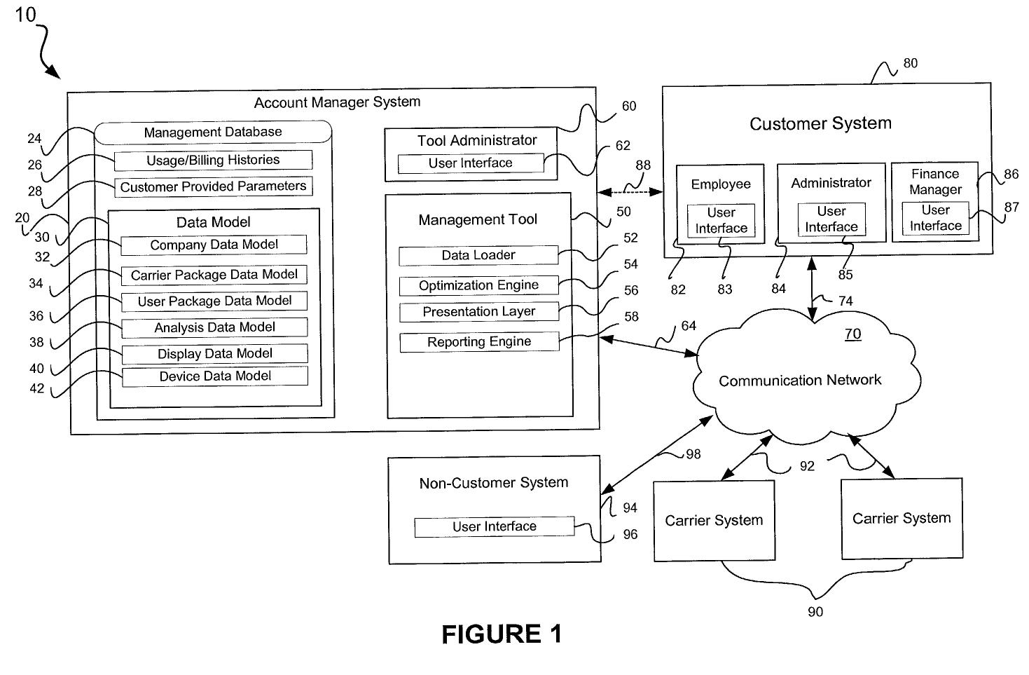

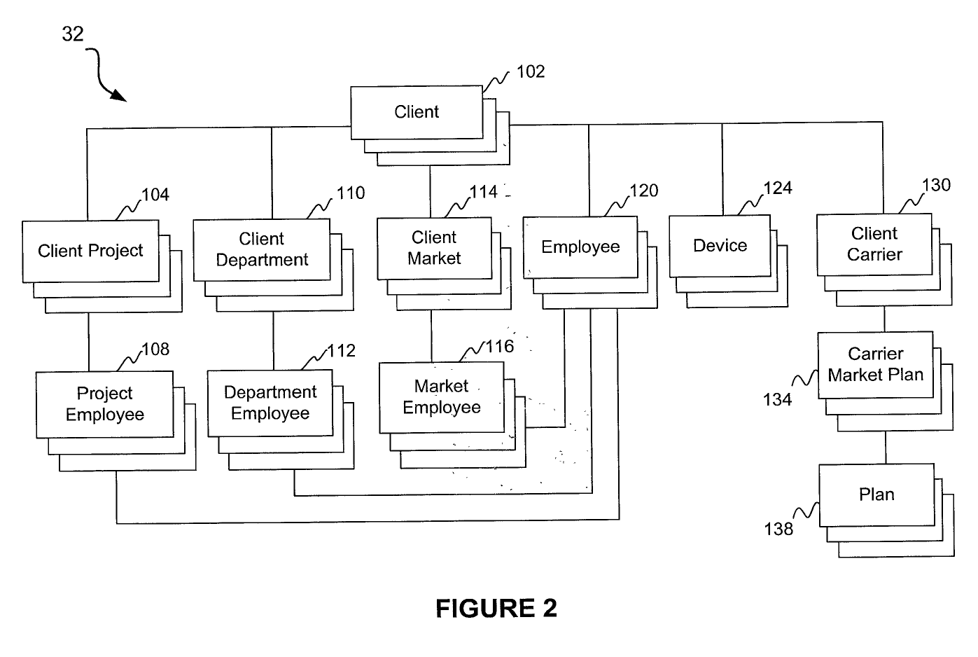

The system includes an optimization engine that further processes the collected data based on customer-provided or default priorities or parameters (such as service in certain markets, only daytime use, anytime use, and many more parameters) to provide a listing of recommended service plan changes. The customer may periodically alter their customer-provided parameters to obtain correspondingly altered recommendations. The system also is adapted for allowing employee usage to be monitored with each intake of new billing information from carriers to identify possible misuse of wireless devices. The system preferably transmits an alert to the customer upon identifying such possible misuse of the customer's assets. These and other features of the wireless account management system and method are described in detail below with reference to FIG. 1 which illustrates an exemplary system (e.g., distributed computing environment) for implementing the system and to FIGS. 2-6 which illustrate data models used to present processed and stored customer and device usage information from carrier invoices.

FIG. 1 illustrates one embodiment of a wireless account management system 10 useful for providing a computerized service to automate the process of analyzing corporate or other larger entity wireless telephone or other communication device bills. The functions and operation of the wireless account management system 10 are described in a client/server, de-centralized computer network environment using a multi-tiered hardware environment (such as using Sun Solaris™ with an Oracle database as the management database engine, Windows NT™ or Windows 2000™ as the application and web server for the management tool, and the Internet as the communication medium). While this is a highly useful implementation of the invention, those skilled in the computer and networking arts will readily appreciate the features and functions of the wireless account management system 10 are transferable to many data communication systems (other than the exemplary one illustrated) that utilize numerous and varied data transfer techniques. These variations to the exemplary wireless account management system 10 are considered within the breadth of the following disclosure and claims.

As illustrated, the wireless account management system 10 includes an account manager system 20 in communication with a customer system 80, wireless service carrier systems 90 (wireless service providers and/or resellers), and a non-customer system 94 via a digital communication network 70 (such as a WAN, LAN, Intranet, or the Internet) and communication links 64, 74, 92, 98 (wired or wireless links). Generally, in operation, the account manager system 20 receives billing information for device users (e.g., employees) of the operator of the customer system 80 via the communication network 70 from the customer system 80 and/or directly from the carrier systems 90 or by other communication paths 88 (such as by delivery of paper bills to the account manager system 20).

The account manager system 20 processes the received bills utilizing the management tool 50 and stores the processed information in the management database 20. Reports are generated by the management tool 50 and viewable at the customer system 80 by accessing the account manager system 20 via the communications network 70 or by a transmitted digital report (or printed forms are mailed to the operator of the customer system 80). The carrier systems 90 are polled periodically for updates in service plans or rates (or this information is automatically delivered to the account manager system 20 by the carrier systems 90). The non-customer system 94 represents a company or entity that has not contracted with or subscribed to the management service provided by the account manager system 20 but is allowed limited access to the system 20 to obtain information on available management services.

The account manager system 20 may include nearly any computer device and may include a tool administrator 60, such as a personal computer or workstation for facilitating data entry and viewing data by an operator with a user interface 62. In one preferred embodiment, the management database 24 is provided using a file server with Sun Solaris™ and an Oracle™ database(s) and the management tool 50 is provided using one or more applications running on an application server and web server (such as an iplanet Web Server and an Inprise Application Server). Note, that the management database 24, the management tool 50, and the tool administrator 60 may be combined and located at a single geographic location (as illustrated) or be located in differing physical locations and be communicatively linked by the communication network 70 or a separate communication network (such as a WAN or LAN).

The management database 24 (e.g., a file server and the like) functions as memory for storing information including, but not limited to, usage/billing histories received from the customer system 80 and/or carrier systems 90 and customer provided parameters 28 indicating a customer's preferences in selecting service plans offered by the carriers 90 (which may be other than simply cost and may vary by market, by project, by company division, and the like). The management database or engine 24 further is arranged or provides a data model set 30 that provides the unique multi-view or access feature of the system 10 that enables different users to access and view different portions of the processed usage/billing histories 26 and other information stored in the management database 24 (such as employee and customer company information and service and rate plan information received from the carrier systems 90). The data model set 30 is shown to include a company data model 32, a carrier package data model 34, a user package data model 36, an analysis data model 38, a display data model 40, and a device data model 42 (each of which will be described in detail with reference to FIGS. 2-6).

The management tool 50 includes a data loader 52 for processing incoming customer system 80, carrier system 90, and billing information and to store the processed information in the database 24. An optimization engine 54 is provided in the tool 50 to use default or customer-provided parameters 28 to further process the usage/billing histories and available carrier rate plans to create recommendations on plan changes that would better meet the priorities of the customer 80 indicated by their provided parameters. A presentation layer 56 is provided for displaying information in the management database 24 to clients accessing the account manager system 20 and to facilitate navigation within the information (e.g., navigation on a Web site provided by the presentation layer 56). The reporting engine 58 is provided to create and transmit reports (and alerts) to the customer system indicating the recommended service plan changes and other information retrieved from the usage/billing histories 26 (such as employee usage/costs broken down by departments or markets and the like). The operation of each of these mechanisms or applications is described more fully below.

Throughout this description, network and computer devices, such as management tool 50, management database 24, tool administrator 60, employee device 82, administrator device 84, finance manager device 86, noncustomer system 94, and carrier systems 90, are described in relation to their function rather than as particular electronic devices and computer architectures. To practice the invention, the computer devices and network devices may be any devices useful for providing the described functions, including well-known data processing and communication devices and systems such as personal computers with processing, memory, and input/output components. Many of the network devices may be server devices configured to maintain and then distribute software applications over a data communications network. The communication links, such as links 64, 74, 92, 98, may be any suitable data communication link, wired (such as a PPP phoneline connection (56K or higher), a T1 or T3 line (ISDN), frame relay, and the like) or wireless, for transferring digital data between two electronic devices (e.g., a LAN, a WAN, an Intranet, the Internet, and the like). In a preferred embodiment, data is communicated in digital format, such as HTTP/HTTPS format, following standard protocols, such as TCP/IP, but this is not a limitation of the invention as data may even be transferred on storage mediums between the devices or in print out form for later manual or electronic entry on a particular device.

The customer system 80 is typically operated by a company or other entity and may include a number of workstations or personal computing devices linked 74 to the communication network 70 to access the account manager system 20. As shown, an employee device 82 with a user interface (such as a graphical user interface with a web browser) is provided for enabling an employee to access at least one of the data models 30 to view their usage information. Similarly, an administrator device 84 with a user interface 85 and a finance manager device 86 with a user interface 87 are provided for allowing personnel having different wireless account management responsibilities to access one or more data models 30 provided by the account manager system 20. A noncustomer system 94 with a user interface 96 is also included in the system 10 to illustrate access to the data model sets 30 provided to entities that are not yet provided customer level access to the data models 30. The data flow and communication between each of these devices is explained below with relation to the various data models 30 and the operation of the management tool 50.

Referring to FIG. 1, the data loader 52 supports the initial processing (e.g., the ingest process) of data utilized by the account manager system 20 to provide wireless management services. The ingested data includes primarily data received from the customer via customer system 80 and links 74 for digital transmitted data and alternative link 88 for other delivery methods (e.g., verbal, printed, and other forms of communication) and from carriers providing wireless services via carrier systems 90 and links 92 (or other communication paths not shown). The primary function of the data loader 52 is to process data in varying formats from different carriers 90 and reformat it into a single format for use in the data models 30.

Initially (and periodically for updates), the data loader 52 acts to ingest or process company information from the customer system 80 including contact information, employee or user information, wireless device information typically including a device identifier (e.g., serial number), market or geographic company information, company division information, and company project information. Processed information is then stored in the management database 20 for later use. Further, the company information preferably includes the designation of a customer administrator and of a finance manager (which have predetermined access to the account manager system).

To facilitate selection of service plan information, it is preferable that the customer system 80 transmits customer-provided parameters 28 that are used by the optimization engine 54 (or default parameters if none are provided) for selecting service plans based on past usage and billing histories 26. For example, the customer may be willing to spend more for a service plan to obtain coverage throughout a particular market for one set of employees and indicate this by more heavily weighting a market service parameter. For a different set of employees (arranged by project, division, market, or other criteria), a daytime service combined with cost may be the most heavily weighted parameters which likely will result in a different service plan recommendation.

Another important source of information that is ingested into the system 20 is service plan and rate information. This information may be gathered in a number of ways such as periodically from the carrier systems 90 (over communication network 70 or otherwise) or from third party sources. In one preferred embodiment, the management tool 50 is adapted to periodically (e.g., daily, weekly, prior to each billing cycle, and the like) poll each carrier system 90 providing service in areas of the world in which customer employees travel or work to obtain the most recent carrier service plan information. In another embodiment, the carrier systems 90 provide service plan updates to the account manager system 20 as they become available. In these ways, the recommendations provided by the optimization engine 54 are based on the most current plan information and customer usage data.

The data loader 52 further functions to ingest or process all bills received by the customer operating the customer system 80 from the carrier systems 90. The bills may be delivered in digital form directly from the carrier systems 90 via communication network 70 or by other delivery methods or from the customer via customer system 80 or by other delivery paths 88 in digital or paper form. Typically, the billing information includes usage patterns (timing, locations, telephone numbers called, and the like) for each device owned by the customer, the cost of the service provided to each device and in some cases, for each call made by a device, and the service plans utilized by each device. The ingested billing information is stored in the usage/billing histories 26 portion of the management database 20.

In some embodiments, the data loader 52 initially places all or portions of the ingested information into a working file. The information in the working file is then reviewed by an operator of the tool administrator 60. Once reviewed, the information is then placed in appropriate files or data structures of the management file server or database 24. The information ingested by the data loader 52 may be processed by batch loading. Additionally, the data loader 52 may provide a company interface accessible by the administrator 84 via user interface 85 to modify the company information (e.g., to add, delete, or modify employees or employee information, to change project, division, and market information, and alter access information such as changing personnel provided administrator or finance manager access levels). Customer or company information may further be added by inputting a spreadsheet or other data structure provided by the customer system 80 to the data loader 52 or by operating a utility in the tool administrator 60 (such as to enter a file of device/employee pairs or other information).

With this basic understanding of the components of the wireless account management system 10, the operation of the system 10 is described with reference to the data structures (e.g., data models 30) and the presentation of and access to data provided by the management tool 50 and manager system 20. This explanation is useful for understanding the relationships or links between the data stored in the management database 24 by the data loader 52 and useful for further discussion the functions of the manager system 20 and management tool 50 within the wireless account management system 10. The data model 30 is an important approach to representing data used for wireless account management that provides multiple but unique perspectives and level of access to the data in the management database 20.

FIG. 2 illustrates the data accessible in the company data model 32, which is a view accessible by the tool administrator 60 via user interface 62. The operator of the tool administrator 60 generally is responsible for managing company information relating to the customer that owns the wireless devices being managed (and operating customer system 80). Typically, the user interface 62 (such as a GUI with web browser) is used to access the management tool 50 which displays a home web page. The web page queries for login information. The login information indicates the user's access identity (such as with an identifier field and with a password) and then the management tool 50 displays data display models available to that user. In this case, an operator of the tool administrator 60 would have a verified access identity that enables them to access (view and/or modify) the data presented in the company data model illustrated in FIG. 2. Hence, the management tool 50 acts as a multiple firewall or security device that only provides a level of access indicated by a user's login access identity.

As shown, client records or files 102 are included in the model 32 for each customer or customer system 80 of the wireless account management system 10. The client record 102 may include a variety of company or entity specific information including, but not limited to, a company name and identification information, physical location or addressing information, designated contacts, administrators, and finance managers, links to prior recommendations, and in some cases, employee alert requirements and analysis parameters (which may alternatively be stored elsewhere in system 20).

Linked to the client records 102 are a number of other records including client project records 104, client department records 110, and client market records 114. These divisions (and others not shown) of the client's employees allows a client to manage their wireless device usage and costs by a number of criteria that support standard business and costing practices. For example, the client may prefer to manage device usage based on a business or geographic market rather than on a company wide basis or by an operating (and sometimes arbitrary) project or division basis for accounting or other reasons. Each of these records 104, 110, 114 includes adequate information to link it to the client 102 and to identify the project, department, or market. Each of these client managing divisions 104, 110, 114 is then linked to employees which are assigned to the particular managing division such as records project employee 108, department employee 112, and market employee 116. Each of these records is obtained from employee records 120 which includes information pertaining to each employee of the client who is assigned a wireless device such as an employee identifier, assigned managerial divisions, overseeing financial manager, and alert levels (in some cases).

The company data model 32 further includes device records 124 for every wireless device owned or leased by the client or customer. The device records 124 include an employee identifier indicating to which employee 120 the device has been assigned, the device identifier or serial number, and the device telephone number. Significantly, the device records 124 include the existing client carrier 130 providing service for the device and under which carrier market plan 134. In some embodiments, the device records 124 further include information or fields containing information on future or planned carrier market plans 134 (e.g., identifying geographic areas, service plans 138 provided in each market, and the like). The specific plans 138 provided under each carrier market plans 134 are linked to the market plans 134 and include information pertaining to specific services provided and rates charged for usage. This information can then be used either to identify devices for which determinations have been made to not renew existing plans and indicating the intended plan to switch to (e.g., to avoid surcharges sometimes associated with switching service plans/carriers) or whether new plans should be considered by the optimization engine 54 for inclusion in later-performed recommendation analyses.

The configuration of the company data model 32 allows an operator of the tool administrator 60 to quickly review and modify data pertaining to customers and to providing proper wireless usage and service plan recommendations. The tool administrator 60 preferably includes applications or tools via the user interface to provide a number of functions including analyzing usage of the account manager system (e.g., web site usage) managing (e.g., adding to, deleting, or updating) client carrier records 130, carrier market plans 134, and plans 138. In this regard, the tool administrator 60 may be operated to manually or automatically enter or ingest these records 130, 134, 138. Further, upon a determination to switch to a new client carrier 130, carrier market plan 134, and/or plan 138, the tool administrator 60 may function to automatically via an included switch engine to update the appropriate device records 124 and the appropriate client carrier records 134. Additionally, the tool administrator 60 typically is operated to update the client records 102 (and associated records 104-124) and specifically, to manage the client's appointed administrator(s) and finance manager(s).

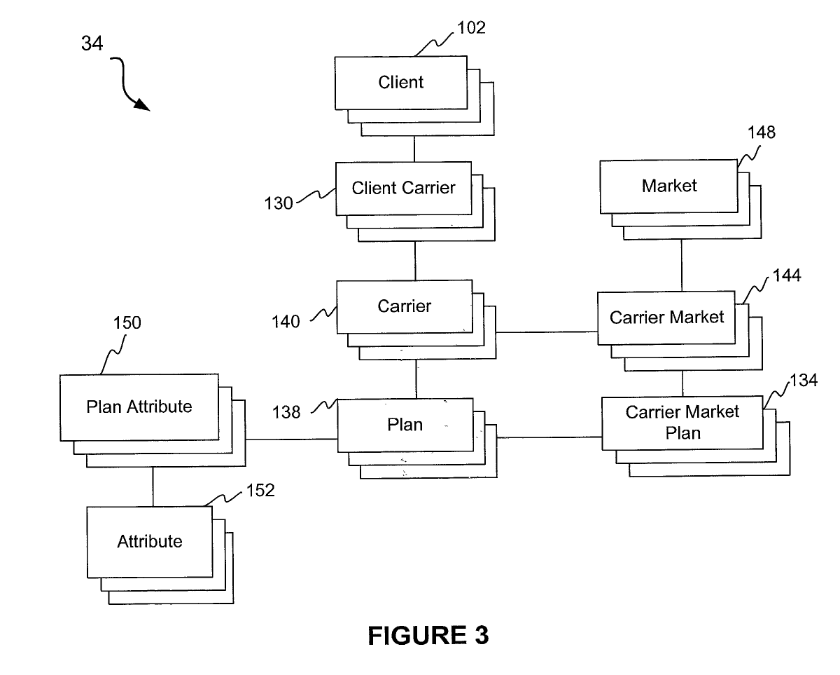

FIG. 3 illustrates the data accessible in the carrier package data model 34, which is another view accessible by the tool administrator 60 via user interface 62. The operator of the tool administrator 60 generally is responsible for managing the data representing and/or provided by the wireless service carriers (systems 90 of FIG. 1). The carrier data that needs to be viewed, updated, and modified is shown in relational form in FIG. 3 and the relations are typically provided by links within a web page but may be provided in other ways. As shown, client records 102 (with content as discussed with reference to FIG. 2) are linked to client carrier records 130, carriers 140 and plans 138 (each with content or fields as described with reference to FIG. 2).

Additionally, the plan records 138 are linked to plan attributes 150. The plan attributes 150 are utilized to describe for each plan 138 the listing of attributes (such as by an attribute identifier and/or name), the cost of the plan (such as by minute, by billing period, and for initial sign up), and the requirements for obtaining or keeping the plan 138. For example, some plans 138 require a minimum number of wireless devices to be serviced under the plan 138. Alternatively, or in addition to, a minimum number of minutes per device or for all of the devices that need to be used (or will be billed regardless of usage) may be set by the carrier 140. Each plan attribute 150 is linked to a more detailed record attribute 152 fully describing each of the plan attributes 150. The plans 138 are further linked to the carrier market plans 134 (as described with reference to FIG. 2).

The carriers 140 are linked to the carrier market records 144 which identify for each carrier 140 the markets (such as a geographic area) serviced by the carrier 140. The market records 148 are provided to fully describe each of the markets, such as by state(s) or geographic regions within a state or states.

A user package data model 36 (shown only in FIG. 1) is a data structure viewable by an employee 82 via user interface 83. Typically, the employee 82 only has a limited access to the data in the management database. The user's view in one embodiment is limited to viewing the client record 102 pertaining to the particular employee 82 and the employee record 120 for the employee 82 detailing their usage stored in the usage/billing histories 26.

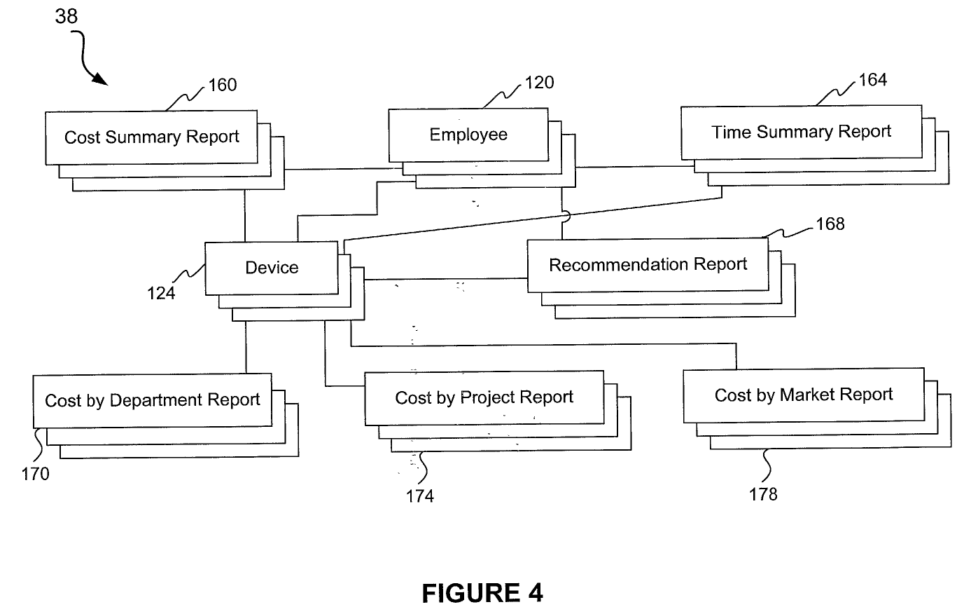

FIG. 4 illustrates the details of the analysis data model 38 which shows the database links and relationships used by the optimization engine 54 as the engine 54 works to select and recommend wireless carrier 130 and plans 138. The recommendations may be performed per device 124 (as shown) or by other basis (such as by client project 104, client department 110, and client market 114). In this data arrangement, each device 124 is linked to an employee 120. During analysis, the optimization engine 54 functions to process the usage/billing histories 26, the customer provided parameters 28, and information in the data model 30 to create the recommendation reports 168 as well as numerous other cost summary and cost reports (i.e., a cost summary report 160, a time summary report 164, a cost by department report 170, a cost by project report 174, and a cost by market report 178.

The recommendation report 168 preferably includes the total minutes of usage by the device 124, the cost under the existing or old plan 138, and significantly, the new cost or cost under the recommended plan 138. Hence, after the analysis is performed by the optimization engine 54, a recommended plan 138 is recommended for each and every device 138. The cost summary report 160 provides a summary of the total cost for each device 124 and each employee 120 which allows sorting of costs by employee rather than just device. The cost summary report 160 further provides a listing of other costs that are useful in analyzing wireless usage and costs, such as average cost for a minute of airtime, plan charges from the carriers, assorted other usage charges such as roaming charges, volume charges, overage charges, directory assistance charges, and the like.

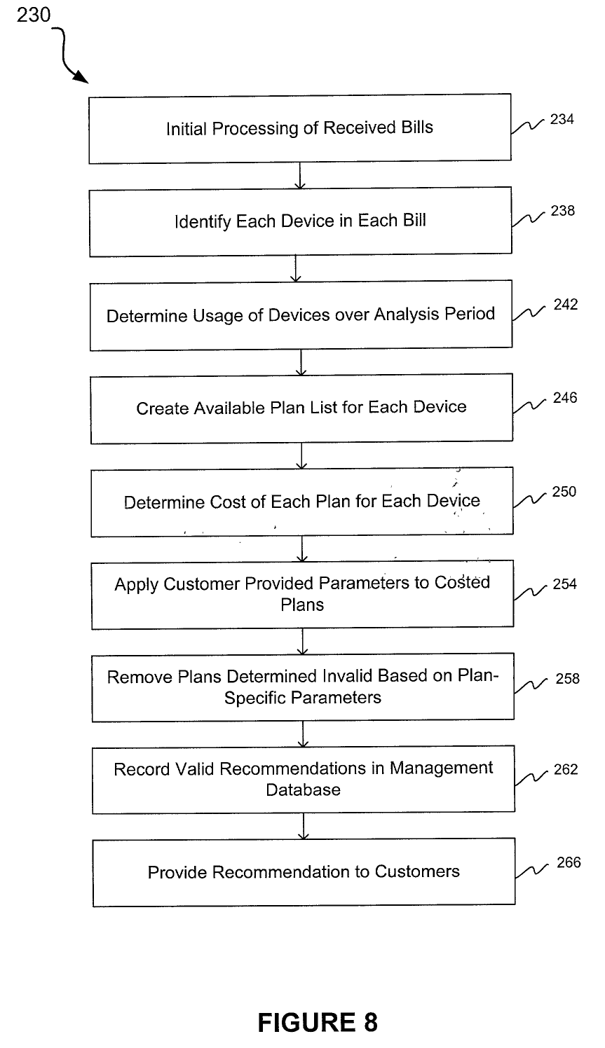

The time summary or usage report 164 is created to detail totals of the usage and its timing. For example, the time summary or usage report 164 lists the billing period, the total usage time, the usage during business hours, the usage in off times, and the usage during peak and off-peak hours. Additionally, the employee's cost relative to the average bill (for the company, the department, the market, or the project) is provided to help identify employees 120 that are misusing the wireless devices 124. Next, reports are provided to indicate the wireless usage costs by department 170, by project 174, and by market 178, which enables the costing to be better managed and better allocated to appropriate company budgets (and for tax purposes). In some preferred embodiments, the cost summary report 160 and the time summary report 164 are combined into a usage report (which is discussed in further detail with reference to FIG. 8).

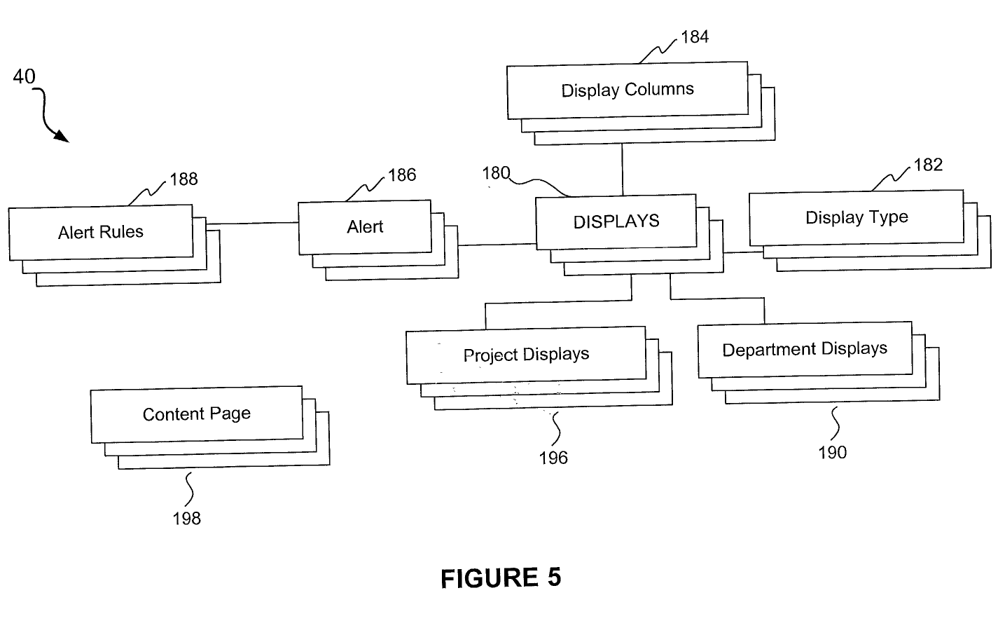

FIG. 5 illustrates the data structure provided by the display data model 40 that is used to control, manage, and build the displays available to the customer system 80. As shown, display records 180 are provided including display identifiers, display names, display types, data arrangements, and client identifiers. The displays 180 are linked to display type records 182, and display column details 184. Displays 180 can also be made specific by project, market, and department as shown by project display records 196 and department display records 190. The data model 40 further includes alerts 186 used to flag to a user that certain alert rules 188 have been met and an alert 186 is created on the display 180. For example, recommendation changes may have been updated and the alert rules 188 may indicate that an alert 186 be provided in the display 180. Further, employee misuse alert rules 188 may have been met causing a misuse alert 186 to be included in a display 180 (or alternatively, by an e-mail sent directly to the customer system 80). Additionally, the data model 40 includes a content page 198 that includes a display description or content (such as an HTML page), a page type, and an address (such as a URL).

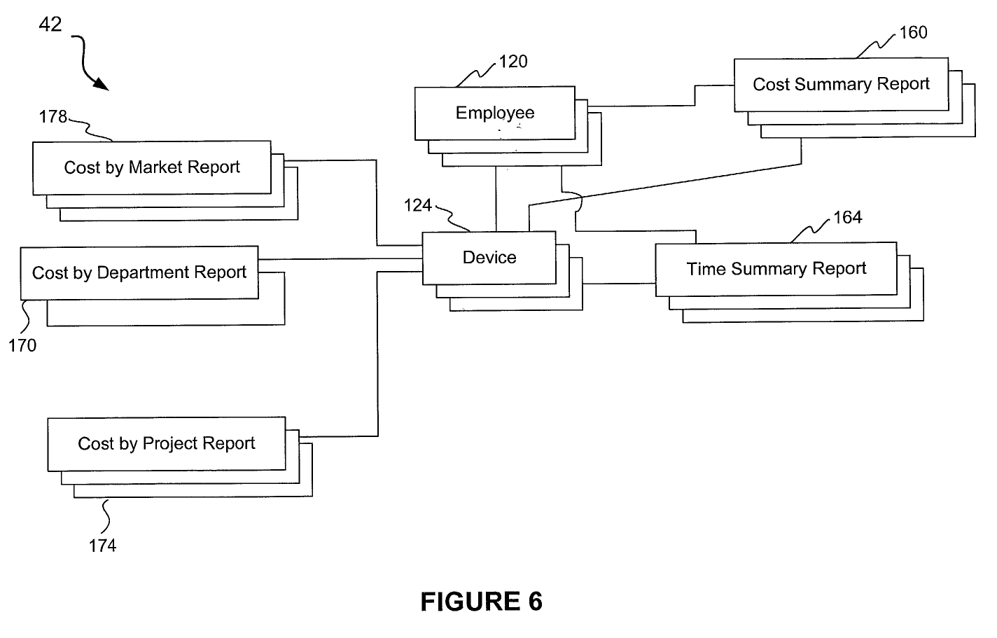

FIG. 6 illustrates the device data model 42 which is the data view perspective of the tool administrator 60 managing the information relating to a client's devices. In this regard, the model 42 provides a record of each device 124 which is again linked to the employee 120 using that device 124. The devices 124 and employees 120 are linked to the cost summary reports 160 and the time summary reports 164 (e.g., the usage reports). The device 124 is further optionally linked to the cost by market reports 178, the cost by department reports 170, and cost by project reports 174.

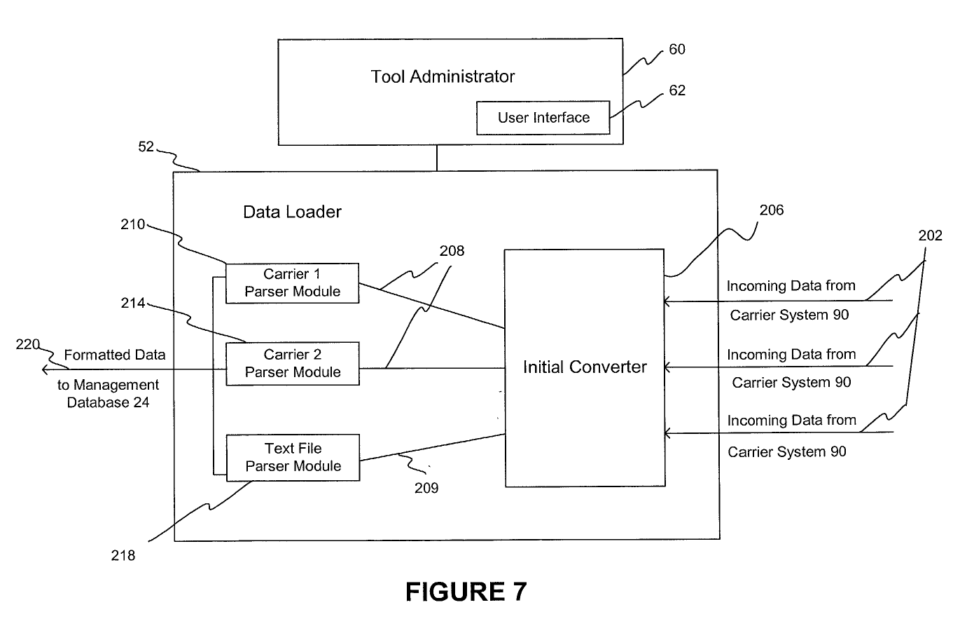

With an understanding of the unique data structures provided by the account manager system 20 to provide varying viewing of, access to, and manipulation of the data in the management database 24, it may be useful to more fully describe the important initial data processing functions provided by the data loader 52 to load the database 24. Generally, data loader 52 is a tool for internal use by the account manager system 20 to facilitate conversion of data received from the various carrier systems 90 in various formats into a single data format suitable for loading into the management database 24. At a high level, the data loader 52 is designed to be convenient and easy to use by a user of the tool administrator 60 to generate the single-format output files from varied-format carrier input files. The data loader 52 allows such output file generation to be accomplished rapidly (such as in a few minutes even when processing large input files and utilizing standard computer processing hardware). The data loader 52 is adapted for being easily updated or modified to handle new carrier inputs that may have yet another data format and data arrangement. These and other features of the data loader 52 will become apparent from the following description of the components of FIG. 7.

One preferred functional arrangement for the data loader 52 is shown in FIG. 7. As shown, incoming data 202 is received from multiple carrier systems 90. The incoming data 202 is typically in numerous digital formats, e.g., a number of formats that is nearly as large as the number of carrier systems 90 in the wireless account management system 10, which makes it very difficult for processing for creating useful reports and plan optimization or selection by the engine 54. For example, the incoming data 202 may be received as Microsoft Access™ files, Adobe™ Portable Data Format (PDF) files, and other standard formats. Additionally, the incoming data may be in print form that first has to be scanned to create a PDF file or text file. A further complication in processing the incoming data 202 is caused by the fact that even when multiple carriers 90 use the same file formatting method (such as Microsoft Access™), each carrier 90 typically uses its own unique method for arranging its information. Hence, each carrier system's 90 incoming data 202 creates a different challenge for processing into a single format output for the management database 24.

To address this problem, the data loader 52 includes an initial converter 206 to extract data from the incoming data 202 to create extracted files 208 and 209 that are transmitted to parser modules 210, 214, 218 which parse the files 208, 209 to create a single-format data output 220 that is sent to the management database 24. Some of the incoming data 202 typically is in a form that is difficult to parse and is converted (which may require removing encryption) by the initial converter 206 into a plaintext format file 209. For example, the incoming data 202 may be received as a PDF file (or be created as a PDF file from a print form) which are converted by the initial converter 206 into a plaintext file 209 for further processing by the text file parser module 218.

For other more readily parsable incoming data files 202 (such as Microsoft Access™), the initial converter 206 extracts data used or desired by the account manager system 20 and transmits the extracted data files 208 to a parser module 210, 214 provided for parsing billing and usage information for a particular carrier system 90. For example, the extracted data files 208 may include an overall carrier bill file, a device bill file that contains a summarized bill for each device, a device bill detail file that contains details of every call for every device (sometimes called Call Detail Records (CDRs)), and a number/name file that provides information linking each device by number to an employee or user.

According to a significant feature of the data loader 52, multiple parser modules 210, 214, and 218 are provided to handle the information from each carrier system 90 for extracted files 208 in more-readily parsed forms and to handle parsing text files 209. The use of multiple carrier parser modules 210, 214 facilitates modification of one module when a carrier changes their provided data 202 formats or addition of new parser modules when new carrier systems 90 are added to and serviced by the system 10. Carrier 1 parser module 210 is configured specifically to parse or interpret one of the carrier system 90 incoming data 202 (e.g., from a first wireless company) and carrier 2 parser module 214 is configured to parse or interpret a second one of the carrier systems 90 incoming data 202 (e.g., from a second wireless company). This is important because even when a similar data format is used by each carrier 90 each carrier will most likely arrange data in a different style and/or provide different amounts and content of data.

In one embodiment, the extracted files 208 are Microsoft Access™ files (or other database or spreadsheet format) that include a number of rows and columns. In each extracted file 208 from a different carrier 90, the columns and rows include different information. Hence, each parser module 210, 214 acts to interpret and handle each column and row differently to suit the data arrangement utilized by the carrier 90. In this fashion, the formatted data output 220 is created to by each parser module 210, 214 to be consistent or a single format for loading in the management database 24. For example, in one preferred embodiment, the single-format output 220 comprises new files of standardized comma-separated-value (CSV) format, which include records with each field being separated by commas. The formatted data files 220 are then loaded by tools (such as those provided by database suppliers, e.g., Oracle and the like, and scripts or mechanisms designed specially for the account manager system 20) into the management database 24.

Parsing text files 209 is a more difficult task that is handled by the text file parser module 218 to create single-format output files 220. One reason the text parsing task performed by the initial converter 206 is difficult is that conversion of PDF and other files to text files 209 is often an imprecise process that can result in data that is not always aligned. Further, depending on the customer 80, a single plaintext file 209 may include information about many individual accounts each with a set of devices or include information for one account with all devices. Further, various types of data, such as account summary data, phone detail data, billing information, and so on, are intermixed in the text data. The intermingling of data types forces the parser module 218 to be configured to be flexible and to quickly recognize the ends of blocks of one type of data and the beginning of a second type of data. Additionally, some carriers 90 may include “suppressed” data that needs to be identified and processed (for example, a listing of CDRs may end abruptly with an indication that further data has been suppressed but can be found later in the file).

To process data that is not aligned or does not line up correctly, the parser module 218 is adapted to process the data in a manner that is similar to human eye and brain processing of data. More particularly, when the human eye scans data, it expects the data to be in a particular range of positions but not necessarily at a fixed location. If the data is not found at a particular or fixed location, the eye continues looking along the line it is reading (in a horizontal and/or vertical direction) up to a certain point or location. If the data is found it keeps processing or else the eye and brain function to determine that additional data is unavailable. The parser module 218 acts similarly by processing the plaintext file 209 by looking for expected data in a specific spot but not failing if it is not there or slightly out of alignment. Instead, the parser module 218 utilizes a search window (with preset ranges or dimensions) in which the parser module 218 continues to search for the expected data. It gathers or parses information within this search window and determines that no more data is available if no data is found.

To handle or parse “suppressed” data, the parser module 218 is configured to recognize to words or flags in a keyword set. The keyword set being populated with suppressed data flags of each carrier system 90 or at least those carriers 90 for which text files 209 are created. During parsing operations, the parser module 218 temporarily halts processing when a suppressed data flag is encountered in the file 209 and the current processing location is stored in memory. The parser module 218 then scans the file 209 to find the suppressed data or records and then returns to the location downstream from the suppressed data flag. The search window and suppressed recognition features of the text file parser module significantly enhance the efficiency and accuracy of parsing plaintext files 209 into a single-format output file 220 (such as a CSV file).

In one preferred embodiment, the parser modules 210, 214, 218 (or in some cases, the initial converter 206 includes an interface application to provide a user of the tool administrator 60 with display windows via the user interface 62 to facilitate conversion and/or extraction of data from the incoming data 202. On a first or main window, the user or administrator selects an incoming data file 202 to process (such as a Microsoft Access™ or a plaintext file). The administrator also uses the main window to indicate where the formatted data output is to be stored and to select the client or customer, the carrier whose information is being processed, and the date of the input data 202 (such as month and year).

A second window (e.g., a location/market associations window) is preferably provided automatically by the data loader 52 during processing when a parser module 210, 214, 218 encounters locations or portions of the data in the files 208, 209 that have not been associated with a market (or other business partition such as a project or division). This second window allows the administrator to enter a market designation for such data. Then, the window may allow the administrator to simply click a button to generate internal account numbers for the location/market combination.

A third window (e.g., a usage association window) may also be provided by the data loader 52 to facilitate plaintext file 209 parsing. In the case of plaintext files 209, there is often text that describes usage that is difficult or impossible to interpret by software tools such as parser module 218. For example, a carrier 90 may include special promotions or offer data in the incoming data 202 (e.g., “sign up now for Performance 875 for next billing period” and the like). Thus, this third window allows an administrator to associate such special text strings with a particular data category used in single-format output 220, e.g., access charges, miscellaneous charges, voice mail charges, web charges, radio charges, text charges, and the like. After the associations are completed, data loader 52 then will recognize the text strings (such as via parser module 218) and places the charges associated with the text strings into the appropriate category in the single-format output 220.

Referring again to FIG. 1, the optimization engine 54 is provided in the management tool 50 to make recommendations for wireless carrier and plan changes based on past usage. In general, these recommendations comprise approximations based on past usage from carrier invoices and customer-provided parameters. In one embodiment, the created recommendations are transmitted, such as by e-mail via the communication network 70, to the customer system 80 to the administrator 84. The administrator 84 can then reply to the recommendation message to indicate whether the changes should be implemented by the management tool 50. In one preferred embodiment, the recommended changes are automatically implemented by the management tool 50 without requiring further input from the customer system 80. After the change is made (such as switching one or more devices to different plans with the same or different service carriers), a plan change notification is transmitted (such as by e-mail) to the customer system 80. The system 20 may be used to order (e.g., purchase or lease) additional devices upon request of the customer system 80 or to replace outdated and costly/inefficient wireless devices (e.g., carriers often offer new devices as part of subscribing to new service plans).

More particularly, FIG. 8 illustrates one optimization process 230 provided by the optimization engine 54 (and/or by the reporting engine 58) to generate the recommendations provided in a recommendations report to the customer system 80 (which the customers may accept or reject to create their own unique service configuration). At 234, the management database 24 is monitored to identify newly arrived bills. Each bill typically provides data for numerous devices including their call information (such as CDRs). Each bill generally has a month and year associated with it (or other billing period) denoting the issue date from the carrier 90. Once identified, each new bill is processed to identify each device for which billing and usage information is provided at 238.

At 242, the recommendation process 230 continues with determining the usage for each of the devices over a preset analysis period. For example, the database 24 may be searched for every bill affecting that device received within the last three months (e.g., a three-month analysis period) and average the usage over this many bills or billing periods. Significantly, a preferred embodiment of the process 230 calls for the use of call detail records (CDRs) for each call made with each device during the analysis period (as defined by the bills not by the actual date the call was made). This information has proven more useful than a mere summary of use because the CDRs allow determination of average call duration, range of call duration, and other detailed call information that enables better selection of plans (e.g., these analysis parameters often indicate a particular service plan is better suited to a device than would have been indicated using summary of use information).

Use of CDRs also allows the process 230 to determine actual call time rather than billed call time (usage information provided by the carrier 90 that is often an overestimate of actual usage) and these times are typically different which sometimes results in differing recommendations. Further, the use of the CDRs preserves more usage information because summarizing methods used by carriers 90 may drop information to usages that are not billed under the current service plan (e.g., long distance or roaming time may not be billed or summarized in specific service plans that offer a fixed fee or free cost for these services). This preserved information is often needed to properly analyze competing service plans for which these services are billed per call and/or call duration. Usage reports (e.g., cost summary reports 160, time summary reports 164, and the like) are also associated with an employee rather than just a device to allow switches or transfers of devices to be accounted for and allow proper monitoring of employee usage of devices.

At 246, a listing of all available service plans is created for each device. These service plans (such as plans 134, 138) are stored in the database 24 and are considered if it meets established business rules (such as customer-provided parameters). For example, the business rules may simply be to evaluate every plan provided by the same carrier in the market of the employee using the device (with a market being a geographic region such as an urban area which shares common access to a set of plans). Alternatively, the business rules, which may be altered to suit a customer's goals, may require that all carriers' plans be considered but that only plans with free long distance and roaming be considered for the device because the device's user (e.g., an employee) is designated by the customer as traveling worldwide. The customer-provided parameters used to define the business rules may be viewed and altered by the administrator 84 of the customer system 80 on a device or employee basis, by market, by project, by division, or on a company-wide basis.

At 250, the cost of each plan in the created available plan list is determined for the analysis period using the previously determined usage or usage pattern from the CDRs. It is assumed that the existing plan is initially the lowest cost and preferred plan to which newly costed plans are compared. The cost of a new plan is determined by applying a series of cost components to the determined usage. Generally, each cost component defines some factor that alters the cost of accepting a new plan for a given device. These cost components include such items as cost of long distance, benefits of having first incoming minute free, cost of optional add on to the new plan, cost of text messaging, cost of web access, saving due to free roaming, and the like. Each plan is ranked by cost after the application of all cost components applicable to the particular plan and the particular usage pattern.

Customer-provided parameters are then applied to the ranked or costed plans at 254 to eliminate plans that do not satisfy the customer's business goals or other criteria. In a simple example, the customer may set a minimum savings value that must be exceeded prior to a plan being recommended (e.g., customer may require a savings of $10/billing period or some other amount prior to switching plans). The type and value of the customer-provided parameters may vary widely and all such parameters are considered within the breadth of this disclosure. Other examples may include a customer invalidating plans based on the carrier (e.g., a customer may refuse to switch to plans from certain service providers), a customer may require web access or some other add-on feature for a project or other set of its employees, a customer may require complete coverage for a specific geographic area, and many other customer specific needs or requirements.

The pared-down recommended plan list is then further evaluated at 258 to remove plans that the device does not qualify due to plan or carrier-specific requirements. For example, the plan may not be available to single devices but may be available if a number of devices are added to the plan. This type of plan will only be recommended if the customer has adequate number of devices to qualify for the plan and the plan is recommended (cost effective) for that number of devices. The plan may have other such plan or carrier specific limitations and each of these is evaluated with “invalid” plans being removed from the recommendation list.

At 262, the valid recommendations for each device are recorded in the management database 24. At 266, the recommendations are provided to the customer system 80. In some embodiments, recommendation reports created by the reporting engine 58 are periodically transmitted to the customer system 80 (such as at the end of each billing period). In most embodiments as explained with reference to the data model 30, the customer system 80 can access the account manager system 20 to view the recommendation reports and billing/usage information 26.

The presentation layer 56 is provided in the management tool 50 functions to provide the content (such as the displays 180 shown in FIG. 5) rapidly and frequently (often with the use of multiple web servers in the system 20). Synchronization of the deployments is important and between devices such as servers used to provide the displays via the management tool 50. This is achieved in part by the storage in the management database 24 of the content portions of static displays (e.g., web pages, such as the content pages 198). All or portions of the stored content for displays is cached for efficient access and presentation by the layer 56. Interfaces for selective access to the content are provided to the tool administrator 60 and the administrator 84 of the customer system 80.

The reporting engine 58 is provided in the management tool 50 to condense newly arriving billing data via link 64 or link 88 into more concise reports (such as usage and recommendation reports). Some exemplary reports include the reports shown in FIG. 6 (reports 160, 164, 170, 174, and 178). In an object-oriented environment, the reports may be configured to determine based on input information (e.g., new billing) whether new reports should be run. Reports are preferably pre-generated and stored in the database 24 to shorten response time to customer system 80 requests. The reports may be transmitted or generated upon request or periodically. E-mail notifications may be used to notify that new reports are available for viewing or delivery or may be used to deliver the reports as they become available.

The reporting engine 58 (or alternatively, the presentation layer 56) is also used to present reports to users (such as customer system 80). In a preferred embodiment, at least portions of each report are actionable by the user or recipient. For example, the reports may be formatted as a web site screen with links to allow retrieval of additional reports or additional related information. The reports may also be in pure text form for e-mailing and/or a clean HTML or other format for printing of hard copies. Preferably, the email reports are manipulable by recipient users such as by moving data or reordering the data display.

As discussed previously, the wireless account management system 10 provides for multiple and differing access by a number of users. A non-customer system (a site visitor) 94 accesses the account manager system 20 to view or retrieve information about the services provided by the system 20. The non-customer system 94 also can view a demonstration of the services and sign up for the services of the system 20. The administrator 84 typically views and can modify different information. The administrator 84 typically can manage projects, divisions, and markets by viewing cost reports broken down in this fashion (see displays of FIG. 5). The administrator 84 further can provide the optimization parameters 28 used in selecting the plans and view and modify employee usage and device assignments. The finance manager 86 differs in that it usually functions to analyze the billing data, to receive employee alerts for misuse, to analyze received reports (or request reports), and manage projects and departments on a higher level.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, the wireless account management system 10 typically will include a large number of customer systems 80 and additional carrier systems. Additional account manager systems 20 are often provided as the number and size of the customer systems and carrier systems increases to provide timely and effective management services as described above. Further, the invention was described for use in managing wireless devices but the features of the invention including the data loader and optimization engine are readily adapted to managing billing and usage for nearly any communication device including standard, wired telephones.

We claim:

1. A method for creating communication service plan recommendations for a client for selection of a service plan from a communication service provider, comprising:
accessing billing files in a memory device to identify a client communication device, wherein the billing files include call detail records from one or more of the communication service providers for calls made with the client communication device;
determining average usage of the client communication device based on the call detail records over an analysis period;
creating a list of service plans available from communication service providers for the client communication device;
calculating a plan cost for each of the service plans on the list for the client communication device based on the determined average usage; and
generating a recommendation report including at least a portion of the service plans on the list arranged in order of calculated plan cost.

2. The method of claim 1, wherein the average use determining includes determining actual call time for the calls made with the client communication device.

3. The method of claim 1, wherein the average use determining includes determining average call duration and a range of call durations from the call detail records.

4. The method of claim 1, wherein the analysis period includes the previous three months.

5. The method of claim 1, further including applying communication service provider criteria for enrollment in the service plans in the recommendation report and removing invalid ones of the service plans for which the communication device does not meet the criteria.

6. The method of claim 1, further including applying analysis parameters provided by the client to the service plans in the recommendation report and removing ones of the service plans not meeting the client-provided parameters.

7. The method of claim 6, wherein the client-provided parameters include a minimum saving amount per billing period.

8. The method of claim 1, further including prior to the accessing of the billing files, receiving billing and usage data from two or more of the communication service providers having at least two data formats, and further including processing the received billing and usage data into single-format output files and storing the single-format output files in the memory device.

9. The method of claim 8, wherein the processing is performed by separate parser modules for each of the communication service providers.

10. The method of claim 8, wherein the processing includes generating plaintext files from at least a portion of the received billing and usage data and wherein the parsing of the plaintext files is performed with a text parser module.

11. A method of processing communications billing data to facilitate analysis, comprising:
receiving input data comprising billing and usage information for communication devices serviced by a communications service provider;
determining whether the input data is in a difficult-to-parse format or in a more-readily-parsable format;
if determined in a difficult-to-parse format:
converting the input data into a text file; and
processing the text file with a text parser into a single format output file; and
if determined in a more-readily-parsable format:
transferring the input data to one of plurality of parser modules adapted for parsing billing and usage information from a particular communications service provider, the one parser module corresponding to the service communication provider that is the source of the received input data; and
processing the input data with the one parser module into an output file having the single format.

12. The method of claim 11, wherein the output file is formatted as a comma-separated-value (CSV) file.

13. The method of claim 11, further including if determined in a more-readily-parsable format, separating the input data into a set of billing and usage files prior to the transferring to the one parser module.

14. The method of claim 13, wherein the set of billing and usage files includes a device bill detail file comprising details of every call for every device serviced by the communications service provider.

15. The method of claim 11, further including providing a set of interactive display windows to a user via a user interface on a computing device, each of the display windows providing parsing information for the input data and allowing the user to provide processing information to effect the processing steps.

16. The method of claim 15, wherein a main window is included in the set of display windows configured to allow the user to select the input file to process and to designate a storage location for the output file.

17. The method of claim 15, wherein a location and market association window is included in the set of display windows configured to indicate unassociated data in the input data and to accept association information from the user to facilitate the processing.

18. The method of claim 15, wherein a usage association window is included in the set of display windows configured to indicate text strings in the text file without a category in the output file and to accept categorization information from the user for use in the processing of the text file into a single-format output file.

19. The method of claim 11, wherein the processing with the text parser includes identifying a suppressed data indicator, retrieving suppressed data in the text file associated with the identified suppressed data indicator, and resuming the processing at a location of the identified suppressed data indicator

20. The method of claim 11, wherein the processing with the text parser includes processing unaligned data using a search window with preset dimensions.

21. A method in a computer system for managing wireless communication device usage for a client, comprising:
storing employee information, device information, and existing carrier and carrier service plan information received from the client, wherein the employee information is linked to device information indicating an employee assigned to use a device and wherein the existing carrier and carrier plan information is linked to the device information indicating for each device an existing carrier and carrier service plan;
processing billing information from the existing carriers to determine usage for the devices based on call detail records in the billing information;
determining a set of preferred service plans from a set of available service plans for each of the devices based on the determined usage; and
providing requesting users differing levels of access to the determined set of preferred service plans and the stored information based on a previously-assigned user access level.

22. The method of claim 21, further including preparing reports including cost and usage summaries for each device, the reports being accessible by the client based on the user access level assigned the client.

23. The method of claim 22, wherein the reports comprise client-specific reports selected from the group of reports consisting of client project reports, client market reports, and client department reports.

24. The method of claim 21, further including receiving a usage alert level from the client for an employee, comparing the usage alert level to the determined usage for the employee, and if the determined usage exceeds the usage alert level, generating an alert.
